(19) United States
(12) Patent Application Publication
(10) Pub. No.: US 2018/0336477 A1
(43) Pub. Date: Nov. 22, 2018

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Takaaki KASHIWAGI, Kanagawa (JP); Kazutoshi YATSUDA, Kanagawa (JP); Masayasu TAKANO, Kanagawa (JP)

(73) Assignee: FUJI XEROX CO., LTD., Tokyo (JP)

(21) Appl. No.: 15/903,341

(22) Filed: Feb. 23, 2018

(30) Foreign Application Priority Data
May 18, 2017 (JP) 2017-099218

(51) Int. Cl. G06N 5/02; G06F 15/18; G06F 9/54

(52) U.S. Cl. CPC G06N 5/025; G06F 9/542; G06F 15/18

(57) ABSTRACT

An information processing apparatus includes: a receiving unit that receives event data including plural event items and values and results of the event items; a model generation unit that generates a model having a tree structure combining the event items and the values of the event items; an extraction unit that extracts, as a rule candidate, a combination of an event item and a value of the event item in the tree in a case where a matching rate between a result obtained by applying the event item and the value of the event item to the model and a result in the event item and the value of the event item is larger than a predetermined value or is equal to or larger than the predetermined value; and a generic rule generation unit that generates a generic rule from plural rule candidates.

### CROSS-REFERENCE TO RELATED APPLICATIONS

This application is based on and claims priority under 35 USC 119 from Japanese Patent Application No. 2017-099218 filed May 18, 2017.

### BACKGROUND

### Technical Field

The present invention relates to an information processing apparatus and a non-transitory computer readable medium.

### SUMMARY

According to an aspect of the invention, there is provided an information processing apparatus including: a receiving unit that receives event data including plural event items and values and results of the event items; a model generation unit that generates a model having a tree structure combining the event items and the values of the event items; an extraction unit that extracts, as a rule candidate, a combination of an event item and a value of the event item in the tree in a case where a matching rate between a result obtained by applying the event item and the value of the event item to the model and a result in the event item and the value of the event item is larger than a predetermined value or is equal to or larger than the predetermined value; and a generic rule generation unit that generates a generic rule from plural rule candidates.

### BRIEF DESCRIPTION OF THE DRAWINGS

An exemplary embodiment of the present invention will be described in detail based on the following figures, wherein:

FIG. 1 is a conceptual module configuration diagram illustrating an example of a configuration according to the present exemplary embodiment;

FIG. 2 is an explanatory view illustrating an example of a system configuration using the present exemplary embodiment;

FIG. 3 is a flowchart illustrating an example of processing according to the present exemplary embodiment;

FIG. 4 is a flowchart illustrating an example of processing according to the present exemplary embodiment;

FIG. 5 is an explanatory view illustrating an example of a data structure of an event data table;

FIG. 6 is an explanatory view illustrating an example of a data structure of a tree-structure model;

FIG. 7 is an explanatory view illustrating an example of processing according to the present exemplary embodiment;

FIG. 8 is an explanatory view illustrating an example of processing according to the present exemplary embodiment;

FIG. 9 is an explanatory view illustrating an example of processing according to the present exemplary embodiment;

FIG. 10 is an explanatory view illustrating an example of processing according to the present exemplary embodiment;

FIG. 11 is an explanatory view illustrating an example of processing according to the present exemplary embodiment;

FIG. 12 is an explanatory view illustrating an example of a data structure of a generic rule table;

FIG. 13 is a flowchart illustrating an example of processing according to the present exemplary embodiment;

FIG. 14 is an explanatory view illustrating an example of a displayed screen according to the present exemplary embodiment;

FIG. 15 is an explanatory view illustrating an example of a displayed screen according to the present exemplary embodiment; and

FIG. 16 is a block diagram illustrating an example of a hardware configuration of a computer that realizes the present exemplary embodiment.

### DETAILED DESCRIPTION

An example of an exemplary embodiment of the present invention is described below with reference to the drawings.

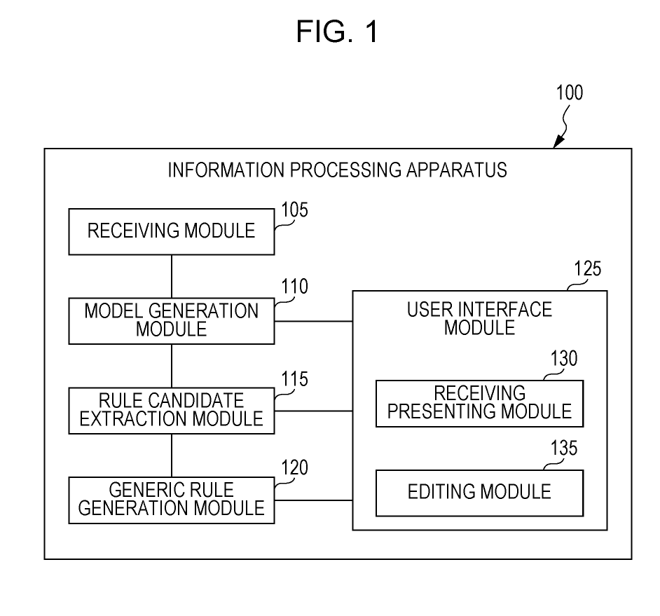

FIG. 1 is a conceptual module configuration diagram illustrating an example of a configuration according to the present exemplary embodiment.

In general, the term “module” refers to software (a computer program) that can be logically separated or a component such as hardware. Accordingly, the term “module” as used in the present exemplary embodiment refers to not only a module in a computer program, but also a module in a hardware configuration. Therefore, the present exemplary embodiment also provides description of a computer program for causing a computer to function as such a module (a program for causing a computer to execute a procedure, a program for causing a computer to function as a unit, or a program for causing a computer to realize a function), a system, and a method. For convenience of description, “store”, “stored”, and equivalent expressions are used. In a case of a computer program, these expressions mean “stored in a memory” or “stored in a memory by controlling”. Modules may correspond one-to-one to functions, but in implementation, a single module may be realized by a single program, plural modules may be realized by a single program, or conversely a single module may be realized by plural programs. Plural modules may be executed by a single computer, or a single module may be executed by plural computers in a distributed environment or a parallel environment. Note that a single module may include other modules. Furthermore, “connection” as used herein refers to not only physical connection, but also logical connection (e.g., exchange of data, an instruction, reference to data). The term “predetermined” means being determined before subject processing and encompasses being determined in accordance with a situation or a state at the time or in accordance with a situation or a state so far as long as the determination is before subject processing not only before start of processing according to the present exemplary embodiment but also after start of processing according to the present exemplary embodiment. In a case where there are plural “predetermined values”, these values may be different from one another or two or more of the values (including all of the values) may be the same as one another. Furthermore, an expression “in a case where A, B is done” means “whether A or not is determined, and B is done in a case where it is determined that A” except for a case where determination as to whether A or not is unnecessary. Furthermore, an expression, such as “A, B, and C”, listing things is listing of examples unless otherwise specified and encompasses a case where only one of them is selected (e.g., only A).

Furthermore, the term “system” or “apparatus” encompasses not only a case where the system or the apparatus is constituted by plural computers, hardware devices, apparatuses, or the like that are connected by communication means such as a network (including one-to-one communication connection), but also a case where the system or the apparatus is constituted by a single computer, hardware device, apparatus, or the like. The terms “apparatus” and “system” are used as synonymous terms. Needless to say, the term “system” does not encompass a “system” in a society (social system) that is artificial arrangement.

For each of processes performed by modules or for each of plural processes performed in a module, target information is loaded from a memory, and a result of the process is read into the memory after the process is performed. Description of loading from the memory before the process and readout into the memory after the process is sometimes omitted. Examples of the memory may include a hard disk, a random access memory (RAM), an external memory medium, a memory connected through a communication line, a register in a central processing unit (CPU).

An information processing apparatus 100 according to the present exemplary embodiment generates a rule for predicting a result from event items and values of the event items, and includes a receiving module 105, a model generation module 110, a rule candidate extraction module 115, a generic rule generation module 120, and a user interface module 125 as illustrated in the example of FIG. 1.

Maintenance of machinery or equipment is described below as a specific example of a scene in which the information processing apparatus 100 is used.

As maintenance of machinery or equipment, regular inspection or exchange of a component is carried out. This regular maintenance is generally carried out on the basis of an estimated lifetime of a component, but a degree of wear of the component varies depending on how the machinery or the equipment is used, and therefore judgement unique to the machinery or the equipment depends on knowledge and experiences of a person in charge of maintenance.

Such maintenance based on knowledge and experiences has problems such as a problem that not everyone can carry out the same level of maintenance, a problem that human judgement is not always the best, and a problem that there is no guarantee that a human error does not occur.

When applied to maintenance of machinery or equipment, the information processing apparatus 100 makes it possible to extract a rule that cannot be recognized by a human and create a maintenance rule for preventing unexpected malfunction.

In the information processing apparatus 100, a tree-structure model combining event items that constitute an event and values of the event items is used. This model may be generated by machine learning or may be generated from a knowledge base generated by a person in charge, as described above.

A reason why especially a model generated by machine learning is used is that data is handled in a black box manner in machine learning and therefore relevance between data that is not recognized by a human can be derived as a model. By extracting this relevance as a rule, a rule that is not recognized by a human can be extracted.

Conventionally, “when and how malfunction occurs by what event” is empirically predicated based on experiences and knowledge of a human. However, by mechanically generating a tree model by machine learning instead of manually generating a combination of event items and values, a combination of events that is not recognized from experiences and knowledge of a human can be discovered.

A reason why plural models are used is as follows.

In machine learning, a structure changes depending on initial parameters at the time of learning, and it cannot therefore be said that a generic rule has been extracted when a single model is used. A generic rule can be generated by creating plural models and extracting a similar rule from the plural models.

Furthermore, there is a reason why a model is not used as it is and instead a rule is extracted. In general, it is very difficult to correctly predict whether machinery is normal or abnormal by machine learning. In the information processing apparatus 100, a rule having a high accuracy rate is selected by selecting a part of high prediction accuracy from the whole tree structure. The “part of high prediction accuracy” is a range common to values of plural rule candidates regarding a value of a common event item, as described later.

Terms used in the description of the present exemplary embodiment are defined as follows.

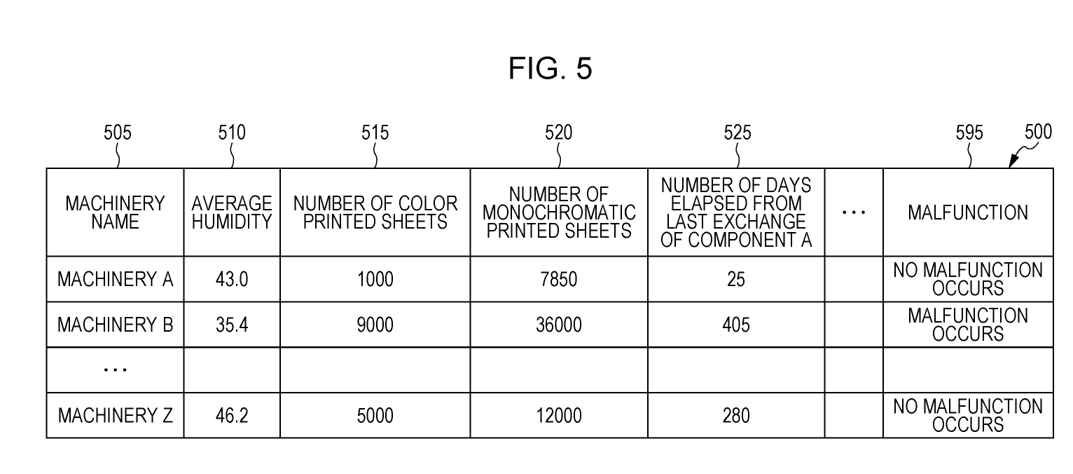

Event data is data combining (1) an event item, (2) a value of the event item, and (3) a result. A specific example of the event data is, for example, an event data table 500 that will be described later with reference to FIG. 5.

A model is a tree-structure model made up of combinations of event items and values of the event items. The model may be a model generated by machine learning or may be a model generated based on a knowledge base created by a person in charge as described above.

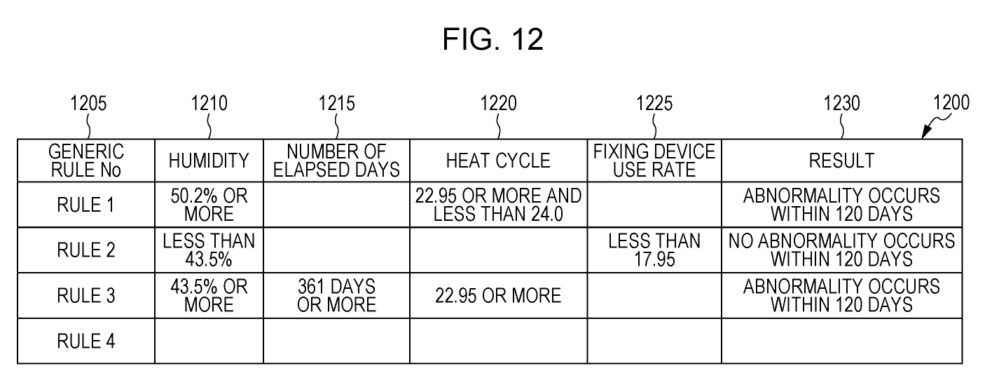

A rule is a combination of an event item and a value. A specific example of the rule is, for example, a generic rule table 1200 that will be described later with reference to FIG. 12.

Each module in the information processing apparatus 100 is described below.

The receiving module 105 is connected to the model generation module 110. The receiving module 105 receives event data including plural event items and values and results of the event items. For example, the receiving module 105 receives the event data table 500 that will be described later with reference to FIG. 5. The receiving module 105 may receive the event data directly from machinery or equipment or may receive the event data from a database device in which the event data is stored.

The model generation module 110 is connected to the receiving module 105, the rule candidate extraction module 115, and the user interface module 125. The model generation module 110 generates a model having a tree structure combining the event items and values of the event items received by the receiving module 105. The model generation module 110 may generate a model having a tree structure by machine learning.

For example, machine learning using a decision tree, a random forest, or the like may be used to generate a “model having a tree structure”. The model generation module 110 may generate a model based on a conventional knowledge base.

The results are results obtained in a case where “event items and values of the event items” are applied to machinery or equipment. Specifically, the results are, for example, “abnormality occurs” and “no abnormality occurs”. Note that the “event items and values of the event items” may be grasped as a situation before results are obtained.

The model generation module 110 may generate plural models.

The rule candidate extraction module 115 is connected to the model generation module 110, the generic rule generation module 120, and the user interface module 125. The rule candidate extraction module 115 extracts, as a rule candidate, a combination of an event item and a value of the event item in the tree in a case where a matching rate between a result obtained by applying the event item and the value of the event item to the model generated by the model generation module 110 and a result in the event item and the value of the event item is larger than a predetermined value or is equal to or larger than the predetermined value.

In the rule candidate extraction module 115, “an event item and a value of the event item” that are applied to a model are not limited, as long as all of an event item, a value of the event item, and a result are prepared. That is, it is only necessary that a result is known in a case where “an event item and a value of the event item” are applied. For example, “an event item and a value of the event item” that are applied to a model may be “an event item and a value of the event item” used for generation of the model or may be “an event item and a value of the event item” other than “an event item and a value of the event item” used for generation of the model.

The rule candidate extraction module 115 may extract a rule candidate for obtaining a result by tracing trees in plural models.

The generic rule generation module 120 is connected to the rule candidate extraction module 115 and the user interface module 125. The generic rule generation module 120 generates a generic rule from plural rule candidates extracted by the rule candidate extraction module 115.

The generic rule generation module 120 may generate a generic rule from rule candidates having a common event item among the plural rule candidates.

The generic rule generation module 120 may use, as a value of a generic rule, a range common to values of plural rule candidates regarding a value of the common event item. For example, a logical AND operation may be performed to extract the “range common to values of plural rule candidates”.

Alternatively, the generic rule generation module 120 may use, as a value of a generic rule, a range including at least one of values of plural rule candidates regarding a value of the common event item. A logical OR operation may be performed to extract the “range including at least one of values”.

The user interface module 125 includes a receiving presenting module 130 and an editing module 135 and is connected to the model generation module 110, the rule candidate extraction module 115, and the generic rule generation module 120.

The receiving presenting module 130 presents a process for extracting a rule candidate or a process for generating a generic rule. The receiving presenting module 130 may present a model generated by the model generation module 110. For example, the receiving presenting module 130 receives user's operation and presents a message or the like to the user by controlling a liquid crystal display that also functions as a touch panel. Alternatively, the receiving presenting module 130 may receive user's operation (examples thereof include a gaze, a gesture, and voice) using a mouse, a keyboard, a camera, a microphone, or the like and may present a message to the user by output of a 3D (dimensions) image, audio output using a speaker, and tactile impression using a tactile device.

The receiving presenting module 130 may present the number of event items and values of the event items applied to a model, a matching rate, or a combination thereof as a process for extracting a rule candidate.

The receiving presenting module 130 may present a range of values of event items by illustration as a process for generating a generic rule.

The receiving presenting module 130 may present a rule candidate or a generic rule in an editable manner. The “editable” is, for example, deletion of the rule candidate or the generic rule or change of a range of a value in the rule.

The editing module 135 edits a rule candidate or a generic rule in accordance with an instruction to edit the rule candidate or the generic rule presented by the receiving presenting module 130.

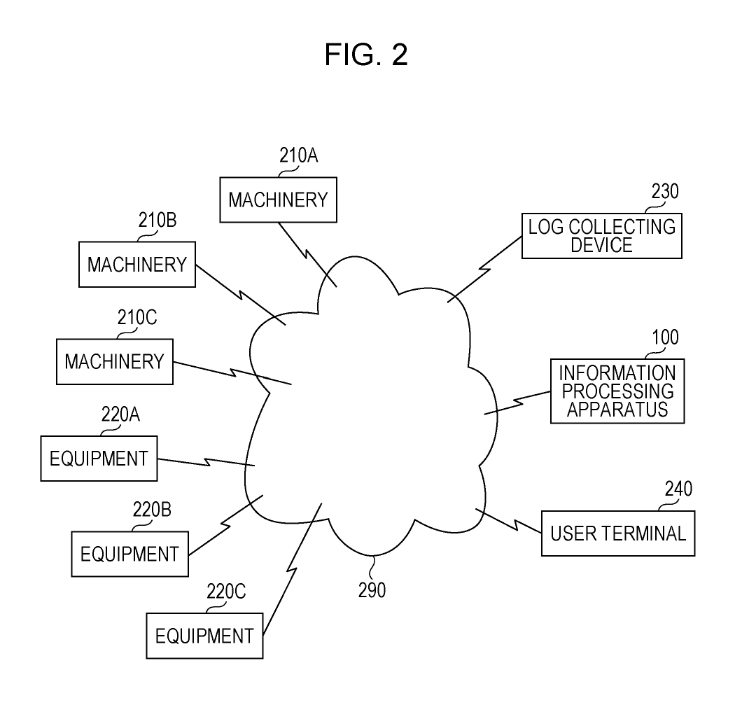

FIG. 2 is an explanatory view illustrating an example of a system configuration using the present exemplary embodiment.

The information processing apparatus 100, machinery such as machinery 210A, equipment such as equipment 220A, a log collecting device 230, and a user terminal 240 are connected to one another through a communication line 290. The communication line 290 may be wireless, wired, or a combination thereof and may be, for example, the Internet or an intranet that is a communication infrastructure. Functions offered by the information processing apparatus 100 and the log collecting device 230 may be realized as a cloud service. The machinery 210 and the equipment 220 are targets to which a rule is to be applied. Examples of the machinery 210 include office machines such as a copying machine, a fax machine, a scanner, a printer, or a multi-function printer (an image processing apparatus having two or more of functions of a scanner, a printer, a copying machine, a fax machine, and the like), information home appliances, and robots. Examples of the equipment 220 include a turnstile and a ticket-vending machine at a railway station, an automated teller machine (ATM) at a bank, and an elevator and an escalator in a building. Examples of the user terminal 240 include a personal computer having a communication function and a mobile information communication device (e.g., a mobile phone, a smartphone, a mobile device, or a wearable computer).

The log collecting device 230 collects event data from the machinery 210 and the equipment 220 and stores the event data therein. Then, the log collecting device 230 supplies the event data to the information processing apparatus 100. The information processing apparatus 100 may directly collect event data from the machinery 210 or the equipment 220 without intervention of the log collecting device 230.

Then, the information processing apparatus 100 generates a generic rule and presents, to the user terminal 240, a process for extracting a rule candidate or a process for generating the generic rule. The information processing apparatus 100 may be configured as a stand-alone type that directly receives user's operation and presents a result.

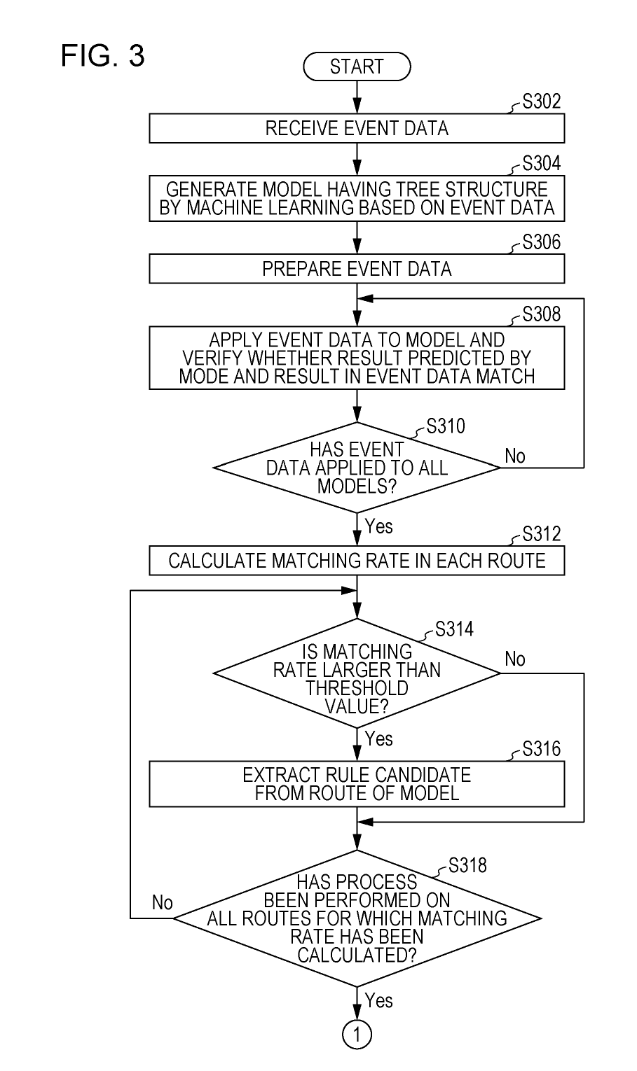

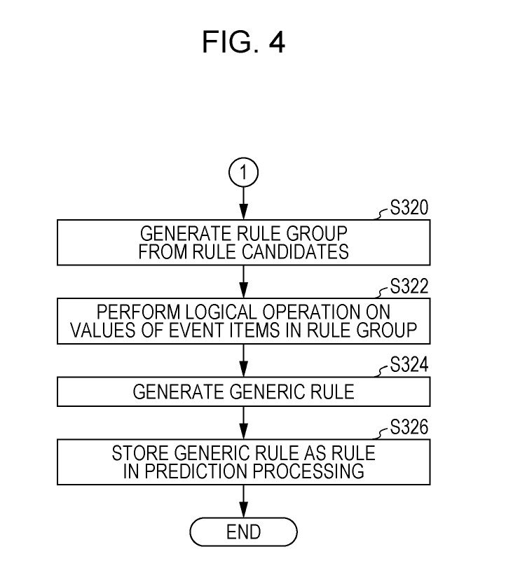

FIGS. 3 and 4 are flowcharts illustrating an example of processing according to the present exemplary embodiment.

In Step S302, the receiving module 105 receives event data. For example, the receiving module 105 receives the event data table 500. FIG. 5 is an explanatory view illustrating an example of a data structure of the event data table 500. The event data table 500 has, for example, a machinery name column 505, an average humidity column 510, a color printed sheet number column 515, a monochromatic printed sheet number column 520, a component A last exchange elapsed day column 525, and a malfunction column 595. The event data table 500 is an example of event data in a multi-function printer. That is, the event data table 500 is made up of plural event items, values of the event items, and results of the event items. The machinery name column 505 stores therein a machinery name (e.g., a model or information by which machinery can be uniquely identified). The average humidity column 510 stores therein average humidity in a place where the machinery is placed (or average humidity in the machinery). The color printed sheet number column 515 stores therein the number of sheets on which a color image is printed by the machinery. The monochromatic printed sheet number column 520 stores therein the number of sheets on which a monochromatic image is printed by the machinery. The component A last exchange elapsed day column 525 stores therein the number of days elapsed from last exchange of a component A in the machinery. The malfunction column 595 stores therein presence or absence of malfunction in the machinery. The average humidity column 510, the color printed sheet number column 515, the monochromatic printed sheet number column 520, the component A last exchange elapsed day column 525, and the like correspond to event items. Values in the respective cells correspond to values of the event items. Values in the malfunction column 595 correspond to results.

In Step S304, the model generation module 110 generates a tree-structure model by machine learning using the event data. For example, the model generation module 110 generates a model from the 120 days' event data table 500 (learning data). That is, a malfunction prediction model is created by machine learning by inputting past learning data acquired for each machinery. The machine learning can be any machine learning for generating a tree-structure model and is, for example, a decision tree or a random forest as described above. A reason why a tree-structure model is used is that a rule can be generated by tracking the tree from a root to a leaf (result).

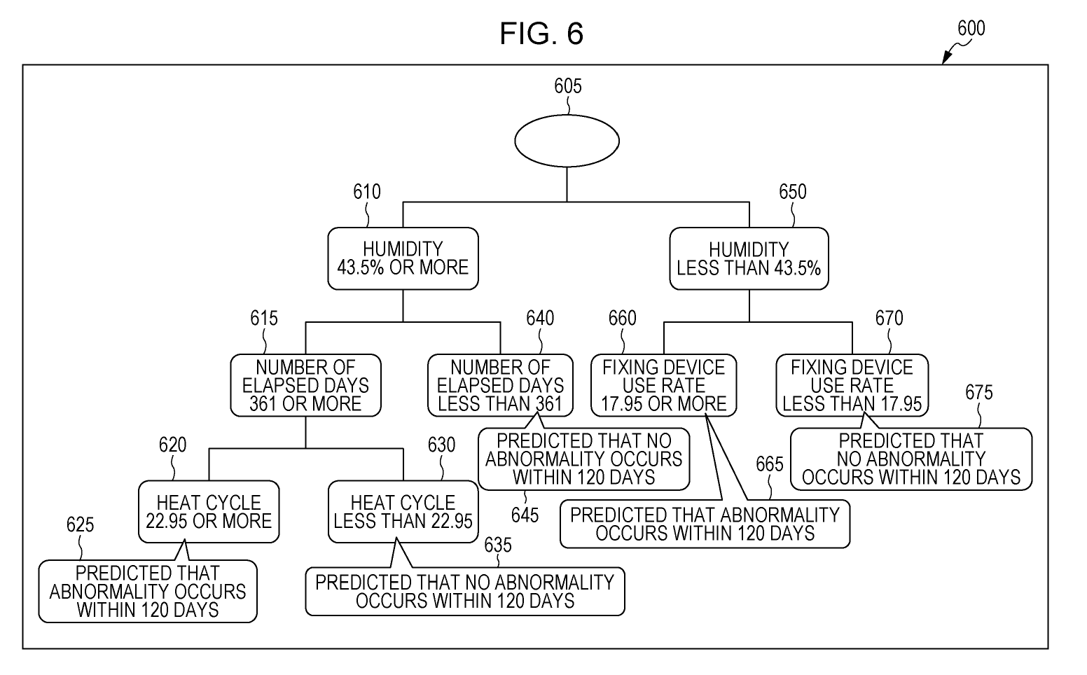

In Step S304, for example, the model generation module 110 generates a tree-structure model 600. FIG. 6 is an explanatory view illustrating an example of a data structure of the tree-structure model 600. The tree-structure model 600 is a model for predicting whether or not an abnormality occurs within 120 days and is an example of a four-layer (depth) tree. Below a root 605, an event item and a value 610 and an event item and a value 650 are located. Below the event item and value 610, an event item and value 615 and an event item and value 640 are located. Below the event item and value 615, an event item and value 620 and an event item and value 630 are located. Below the event item and value 650, an event item and value 660 and an event item and value 670 are located.

In the example of FIG. 6, the event item and value 610 is “humidity 43.5% or more”, the event item and value 615 is “the number of elapsed days 361 or more”, the event item and value 620 is “heat cycle 22.95 or more”, the event item and value 630 is “heat cycle less than 22.95”, the event item and value 640 “the number of elapsed days less than 361”, the event item and value 650 “humidity less than 43.5%”, the event item and value 660 is “fixing device use rate 17.95 or more”, and the event item and value 670 is “fixing device use rate less than 17.95”. A result 625 is “predicted that abnormality occurs within 120 days”, a result 635 is “predicted that no abnormality occurs within 120 days”, a result 645 is “predicted that no abnormality occurs within 120 days”, a result 665 is “predicted that abnormality occurs within 120 days”, and a result 675 is “predicted that no abnormality occurs within 120 days”. For example, this shows that it is predicted that the result 625 (“abnormality occurs within 120 days”) is obtained in a case of the event item and value 610 (humidity 43.5% or more), the event item and value 615 (the number of elapsed days 361 or more), and the event item and value 620 (heat cycle 22.95 or more).

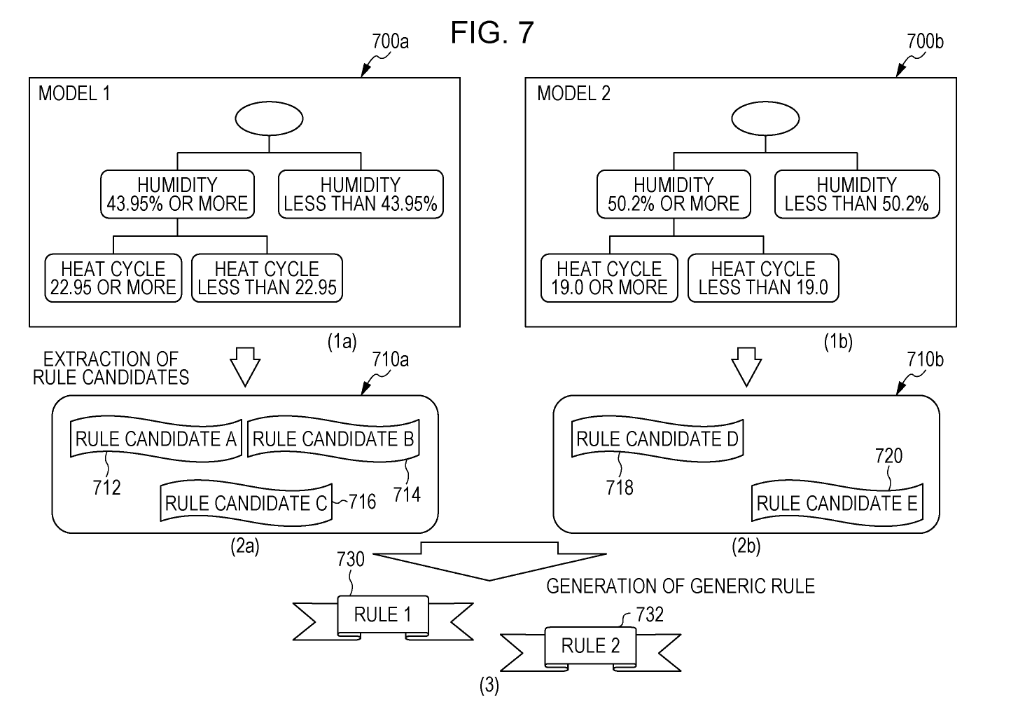

The model generation module 110 generates plural such models. For example, the model generation module 110 generates plural models (a tree-structure model 1: 700a and a tree-structure model 2: 700b) as illustrated in (1a) and (1b) of FIG. 7. For simplification of description, the number of layers is smaller (two layers) than the tree-structure model 600 illustrated in the example of FIG. 6.

Processes performed after this step (after Step S306) are outlined below.

Plural rule candidates are extracted from the plural models. For example, a rule candidate group 710a (a rule candidate A: 712, a rule candidate B: 714, and a rule candidate C: 716) is extracted from the tree-structure model 1: 700a, and a rule candidate group 710b (a rule candidate D: 718 and a rule candidate E: 720) is extracted from the tree-structure model 2: 700b, as illustrated in (2a) and (2b) of FIG. 7.

Then, a generic rule is generated from these rule candidate groups. For example, a generic rule 730 and a generic rule 732 are generated as illustrated in (3) of FIG. 7.

In Step S306, the rule candidate extraction module 115 prepares event data. That is, event data to be applied to the models generated in Step S304 is prepared. Needless to say, the event data is data for which results are known. The event data may be learning data (the event data received in Step S302) or may be event data other than learning data.

In Step S308, the rule candidate extraction module 115 applies the event data to the models and verifies whether or not results predicted by the models and results in the event data match.

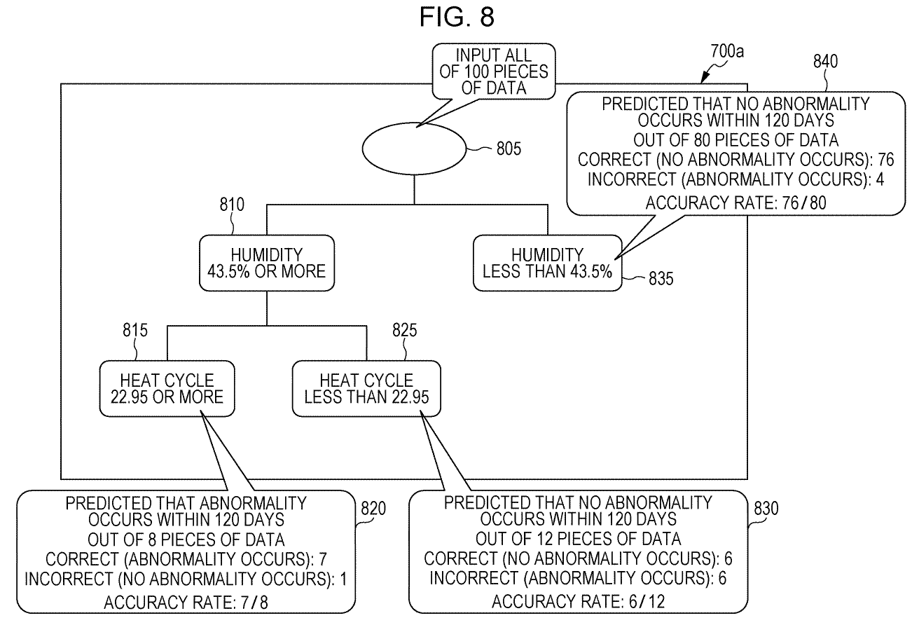

For example, an application result 820, an application result 830, and an application result 840 are generated as results of verification of respective routes (nodes from a root to leaves), as illustrated in FIG. 8. The tree-structure model 1: 700a is a model for predicting whether or not an abnormality occurs within 120 days.

Below a root 805, an event item and a value 810 and an event item and a value 835 are located. Below the event item and value 810, an event item and a value 815 and an event item and a value 825 are located. In the example of FIG. 8, the event item and value 810 is “humidity 43.5% or more”, the event item and value 815 is “heat cycle 22.95% or more”, the event item and value 825 is “heat cycle less than 22.95”, and the event item and value 835 is “humidity less than 43.5%”. The application result 820 is “predicted that abnormality occurs within 120 days, out of 8 pieces of data, correct (abnormality occurs): 7, incorrect (no abnormality occurs): 1, accuracy rate: 7/8”, the application result 830 is “predicted that no abnormality occurs within 120 days, out of 12 pieces of data, correct (abnormality occurs): 6, incorrect (no abnormality occurs): 6, accuracy rate: 6/12”, and the application result 840 is “predicted that no abnormality occurs within 120 days, out of 80 pieces of data, correct (no abnormality occurs): 76, incorrect (abnormality occurs): 4, accuracy rate: 76/80”.

In Step S310, the rule candidate extraction module 115 determines whether or not the event data has been applied to all of the models. In a case where the event data has been applied to all of the models, Step S312 is performed. In other cases, Step S308 is performed again.

In Step S312, the rule candidate extraction module 115 calculates a matching rate (accuracy rate) in each route. The matching rate is as follows in the example of FIG. 8.

[1] If “humidity is 43.5% or more” (the event item and value 810) and “heat cycle is 22.95 or more” (the event item and value 815), it is predicted that “abnormality occurs within 120 days”, and it is found as a result of verification that 7 pieces of data out of 8 pieces of data of the event data are correct (abnormality occurs) and 1 piece of data out of 8 pieces of data of the event data is incorrect (no abnormality occurs). That is, an accuracy rate is 7/8 (87.5%).

[2] If “humidity is 43.5% or more” (the event item and value 810) and “heat cycle is less than 22.95” (the event item and value 825), it is predicted that “no abnormality occurs within 120 days”, and it is found as a result of verification that 6 pieces of data out of 12 pieces of data of the event data are correct (no abnormality occurs) and 6 piece of data out of 12 pieces of data of the event data are incorrect (abnormality occurs). That is, an accuracy rate is 6/12 (50%).

[3] If “humidity is less than 43.5%” (the event item and value 835), it is predicted that “no abnormality occurs within 120 days”, and it is found as a result of verification that 76 pieces of data out of 80 pieces of data of the event data are correct (no abnormality occurs) and 4 piece of data out of 80 pieces of data of the event data are incorrect (abnormality occurs). That is, an accuracy rate is 76/80 (95%).

In Step S314, the rule candidate extraction module 115 determines whether or not “a matching rate is larger than a threshold value”. In a case where “a matching rate is larger than the threshold value”, Step S316 is performed. In other cases, Step S318 is performed. For example, in a case where the threshold value is 80%, [1] “the event item and value 810 and the event item and value 815) and [3] (the event item and value 835) become rule candidates (Step S316) in the example of FIG. 8 (Step S316). A threshold value for a case where no abnormality occurs and a threshold value for a case where an abnormality occurs may be made different so that a more useful rule candidate can be generated.

In Step S316, the rule candidate extraction module 115 extracts a rule candidate from the route in the model.

In Step S318, the rule candidate extraction module 115 determines whether or not the process has been performed for each of the routes for which a matching rate has been calculated. In a case where the process has been performed for all of the routes, Step S320 is performed. In other cases, Step S314 is performed again.

In Step S320, the generic rule generation module 120 generates a rule group from the rule candidates.

The following rules (predetermined rules) are applied to plural rule candidates, and a rule group is created by regarding rule candidates that meet the rules as the same rule group.

(Rule 1) rule candidates have the same event item and the same prediction result

(Rule 2) event items of one rule candidate include an event item of another rule candidate, and the rule candidates have the same prediction result

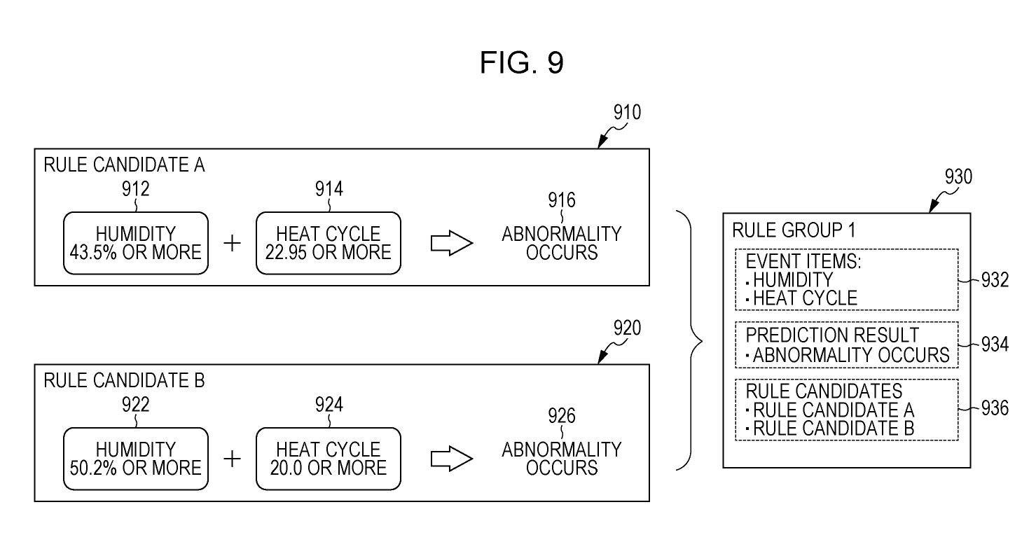

(Rule 1) is described by using the example of FIG. 9.

A rule candidate A: 910 shows that a prediction result 916 is obtained (it is determined that an abnormality occurs) in a case of an event item and a value 912 (humidity 43.5% or more) and an event item and a value 914 (heat cycle 22.95 or more).

A rule candidate B: 920 shows that a prediction result 926 is obtained (it is determined that an abnormality occurs) in a case of an event item and a value 922 (humidity 50.2% or more) and an event item and a value 924 (heat cycle 20.0 or more).

The event items of the rule candidate A: 910 are humidity and heat cycle, and the event items of the rule candidate B: 920 are humidity and heat cycle. That is, the rule candidate A: 910 and the rule candidate B: 920 have the same event items. Although the rule candidates need have the same event item, values of the event item need not be the same (e.g., 43.5% or more). The prediction result 916 of the rule candidate A: 910 is “abnormality occurs”, and the prediction result 926 of the rule candidate B: 920 is “abnormality occurs”. That is, these rule candidates have the same prediction result. Accordingly, a rule group 1: 930 is created. The rule group 1: 930 is made up of event items 932, a prediction result 934, and rule candidates 936.

In a case where there is a rule candidate having the same event item and the same prediction result as a rule group that has been already created, the rule candidate need just be added to rules of the rule group. For example, in a case where there is a rule candidate X whose event items are humidity and heat cycle and whose prediction result is “abnormality occurs”, it is only necessary to add the rule candidate X to the rule candidate 936 since the event items and the prediction result of the rule candidate X are the event items 932 and the prediction result 934 that are the same as those of the rule group 1: 930.

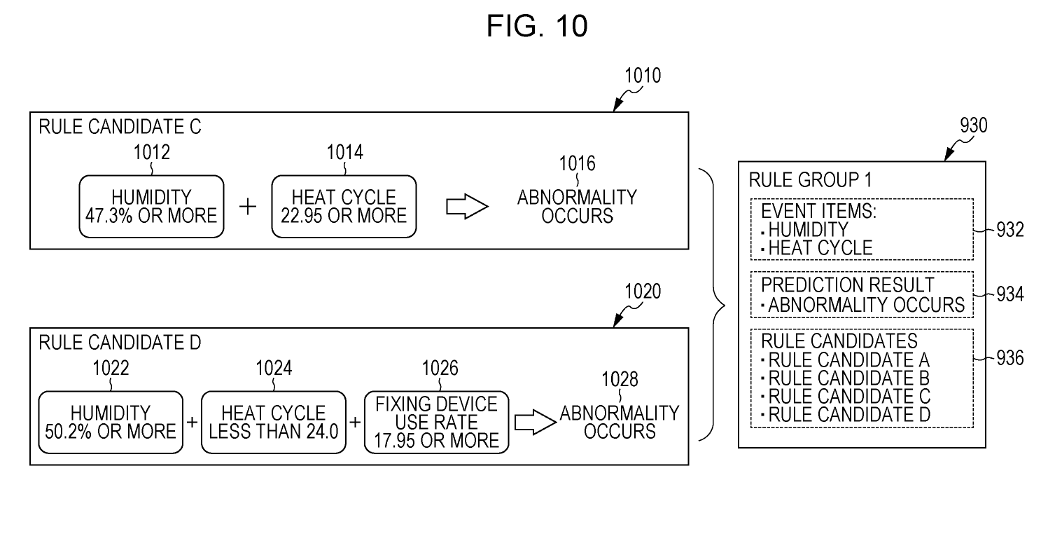

(Rule 2) is described by using the example of FIG. 10.

A rule candidate C: 1010 shows that a prediction result 1016 is obtained (it is determined that an abnormality occurs) in a case of an event item and a value 1012 (humidity 47.3% or more) and an event item and a value 1014 (heat cycle 22.95 or more).

A rule candidate D: 1020 shows that a prediction result 1028 is obtained (it is determined that an abnormality occurs) in a case of an event item and a value 1022 (humidity 50.2% or more), an event item and a value 1024 (heat cycle less than 24.0), and an event item and a value 1026 (fixing device use rate 17.95 or more).

The event items of the rule candidate C: 1010 are humidity and heat cycle, and the event items of the rule candidate D: 1020 are humidity, heat cycle, and fixing device use rate, and therefore the event items of the rule candidate D: 1020 include the event items of the rule candidate C: 1010. Although the same event item need be included, a value of the event item need not be the same (e.g., 47.3% or more). The prediction result 1016 of the rule candidate C: 1010 is “abnormality occurs”, and the prediction result 1028 of the rule candidate D: 1020 is “abnormality occurs”. That is, the rule candidate C: 1010 and the rule candidate D: 1020 have the same prediction result. Therefore, the rule candidate C: 1010 and the rule candidate D: 1020 are regarded as belonging to the same rule group. Since the event items and the prediction result of the rule candidate C: 1010 are the same as the event items and the prediction result of the rule group 1: 930, the rule candidate C: 1010 and the rule candidate D: 1020 are added to the rule candidate 936 of the rule group 1: 930. However, a different event item (specifically, a fixing device use rate, which is an event item of the event item and value 1026) is not added to the event items 932 of the rule group 1: 930.

In a case where event items of one rule candidate include an event item of another rule candidate, the number of different event items may be limited. For example, the number of different event items may be limited to a number less than a predetermined number or may be limited to a number equal to or less than a predetermined number. Alternatively, for example, the number of different event items may be limited to a number less than the number of same event items or may be limited to a number equal to or less than the number of same event items.

In Step S322, the generic rule generation module 120 performs a logical operation on values of event items in a rule group.

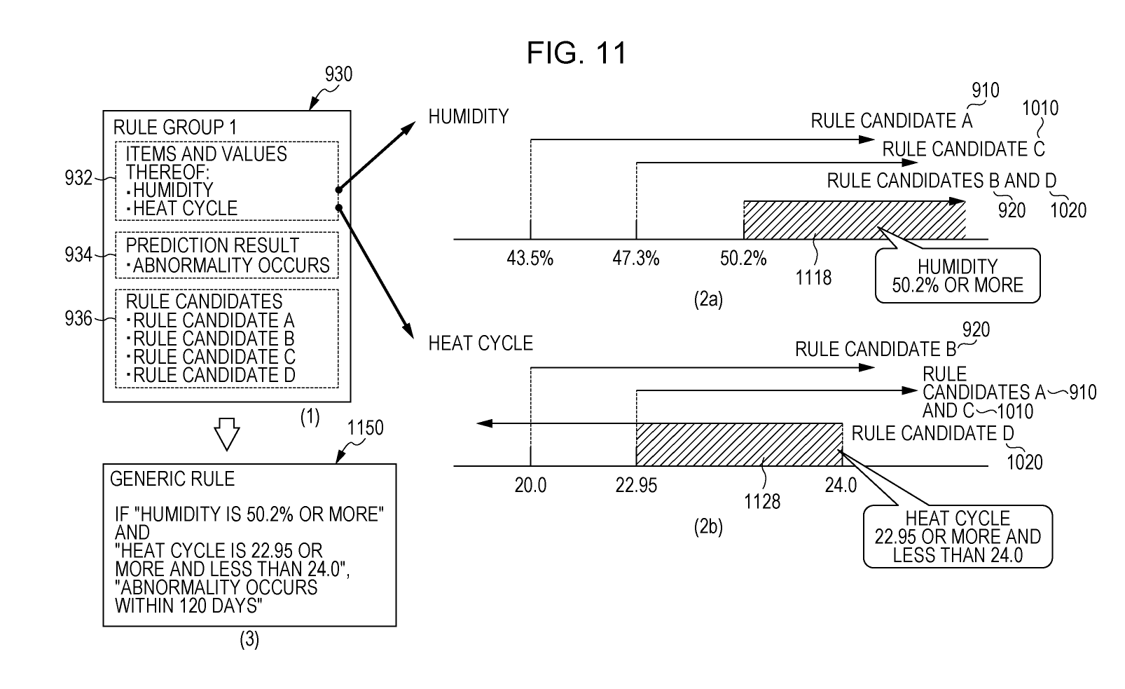

The process in Step S322 is described with reference to the example of FIG. 11. As illustrated in the example of (1) of FIG. 11, the rule group 1: 930 illustrated in the example of FIG. 10 is used. The event items 932 are humidity and heat cycle. The rule candidates 936 are the rule candidate A: 910, the rule candidate B: 920, the rule candidate C: 1010, and the rule candidate D: 1020.

First, as for the humidity out of the event items 932, a range common to the values of the event item of the respective rule candidates is extracted. As illustrated in the example of (2a) of FIG. 11, the value of the event item is 43.5% or more in the case of the rule candidate A: 910, the value of the event item is 47.3% or more in the case of the rule candidate C: 1010, and the value of the event item is 50.2% or more in the case of the rule candidate B: 920 and the rule candidate D: 1020. Accordingly, a common range 1118 (humidity 50.2% or more) is extracted as the range common to the values of the event item of the respective rule candidates (logical AND).

Next, as for the heat cycle out of the event items 932, a range common to the values of the event item of the respective rule candidates is extracted. As illustrated in the example of (2b) of FIG. 11, the value of the event item is 20.0 or more in the case of the rule candidate B: 920, the value of the event item is 22.95 or more in the case of the rule candidate A: 910 and the rule candidate C: 1010, and the value of the event item is less than 24.0 in the case of the rule candidate D: 1020. Accordingly, a common range 1128 (heat cycle 22.95 or more and less than 24.0) is extracted as the range common to the values of the event item of the respective rule candidates (logical AND).

Although an example in which a range common to values of plural rule candidates is used as a value of a generic rule has been described above, a range including at least one of values of plural rule candidates (logical OR) may be used as a value of a generic rule.

In Step S324, the generic rule generation module 120 generates a generic rule.

In the example of FIG. 11, the generic rule generation module 120 generates a generic rule 1150 from the rule group 1: 930. The generic rule generation module 120 uses the event items and the prediction result of the rule group 1: 930 as event items and a prediction result of the generic rule 1150. The generic rule generation module 120 uses the result of the process in Step S322 as values of the event items. That is, the generic rule generation module 120 generates, as the generic rule 1150, ““abnormality occurs within 120 days” if “humidity is 50.2% or more” and “heat cycle is 22.95 or more and less than 24.0””.

In Step S326, the generic rule generation module 120 stores the generic rule as a rule in a prediction process. For example, the generic rule generation module 120 generates a generic rule table 1200. FIG. 12 is an explanatory view illustrating an example of a data structure of the generic rule table 1200. The generic rule table 1200 has a generic rule No column 1205, a humidity column 1210, an elapsed days column 1215, a heat cycle column 1220, a fixing device use rate column 1225, and a result column 1230. The generic rule No column 1205 stores therein information (generic rule No) for uniquely identifying a generic rule. The humidity column 1210 stores therein a value of humidity that is an event item. The elapsed days column 1215 stores therein a value of the number of elapsed days that is an event item. The heat cycle column 1220 stores therein a value of heat cycle that is an event item. The fixing device use rate column 1225 stores therein a value of a fixing device use rate that is an event item. The result column 1230 stores therein a prediction result predicted in a case where conditions of these event items are met.

Rule 1 is that ““abnormality occurs within 120 days” if “humidity is 50.2% or more” and “heat cycle is 22.95 or more and less than 24.0””, Rule 2 is that ““no abnormality occurs within 120 days” if “humidity is less than 43.5%” and “fixing device use rate is less than 17.95””, and Rule 3 is that ““abnormality occurs within 120 days” if “humidity is 43.5% or more”, “the number of elapsed days is 361 or more”, and “heat cycle is 22.95 or more””. Use of machine learning makes it possible to automatically extract not only a combination of event item and value thereof that is understood by a human, but also a combination of event item and value thereof that is not understood by a human from event items and values thereof that can be collected from machinery or equipment. Furthermore, not only rules are extracted from a result of machine learning, but also a generic rule is extracted from the rules.

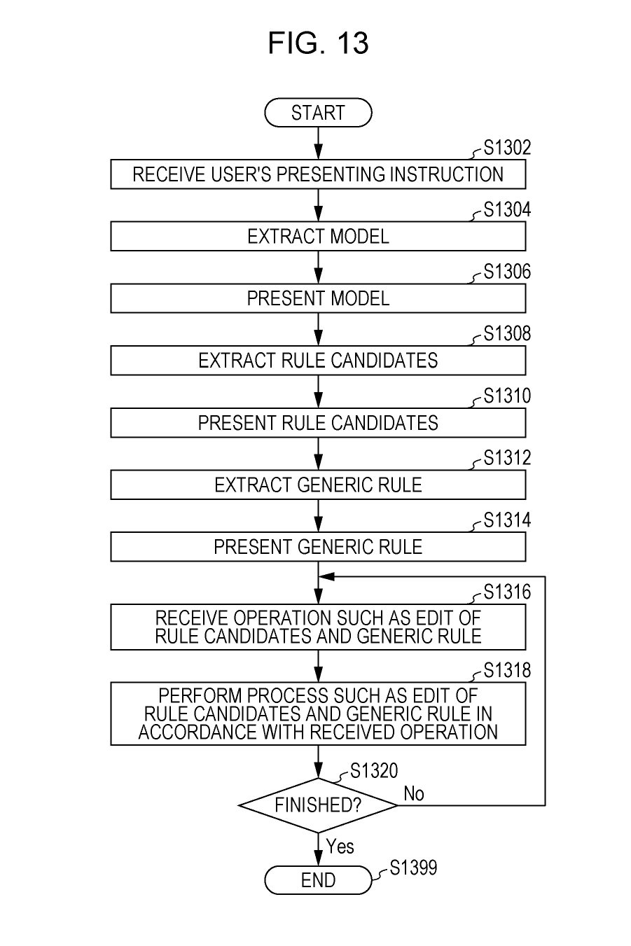

FIG. 13 is a flowchart illustrating an example of processing according to the present exemplary embodiment (performed mostly by the user interface module 125).

In Step S1302, the receiving presenting module 130 receives a user's presenting instruction. What is presented is any one of a model (tree structure) obtained as a result of machine learning, a rule candidate, and a generic rule or a combination thereof. The following discusses an example in which a model, a rule candidate, and a generic rule are presented.

In Step S1304, the editing module 135 extracts a model. In Step S1306, the editing module 135 presents the model.

In Step S1308, the editing module 135 extracts a rule candidate.

In Step S1310, the editing module 135 presents the rule candidate.

In Step S1312, the editing module 135 extracts a generic rule.

In Step S1314, the editing module 135 presents the generic rule.

In Step S1316, the editing module 135 receives, for example, user's operation of editing a rule candidate and a generic rule.

In Step S1318, the editing module 135, for example, edits the rule candidate and the generic rule in accordance with the user's operation.

In Step S1320, the editing module 135 determines whether or not the edit has been finished and finishes the processing in a case where the edit has been finished (Step S1399). In other cases, Step S1316 is performed again.

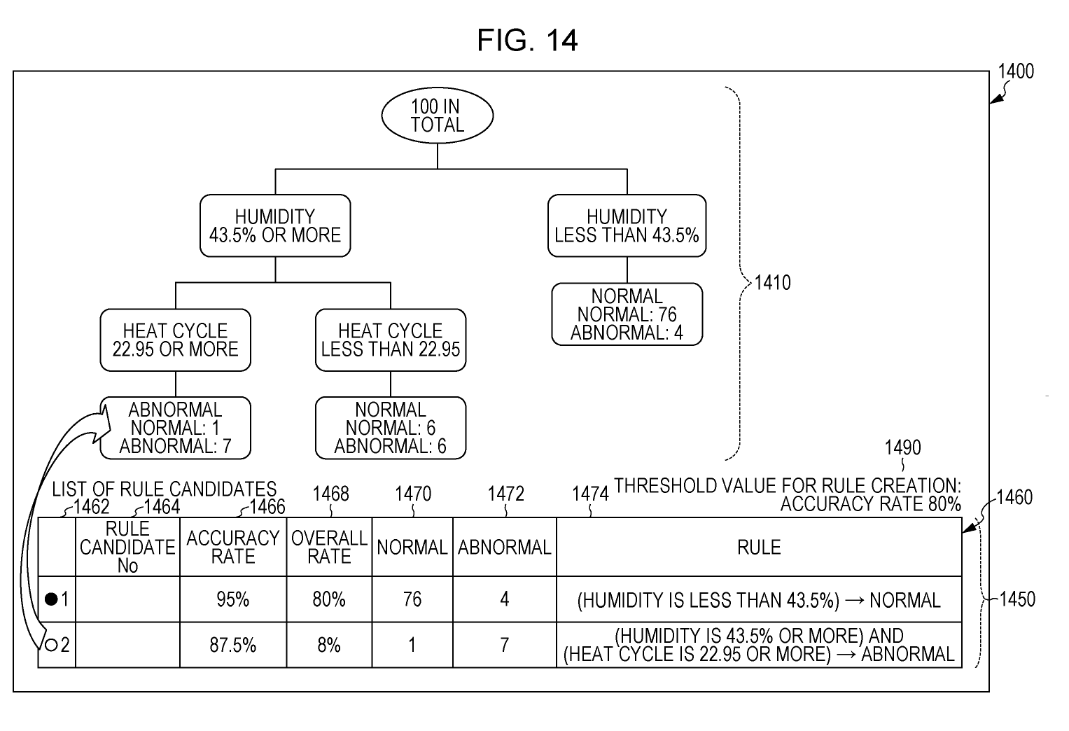

FIG. 14 is an explanatory view illustrating an example of a screen displayed according to the present exemplary embodiment (mostly by the user interface module 125).

A screen 1400 displays a model display region 1410 and a rule candidate display region 1450.

The model display region 1410 displays a model generated by machine learning (may display a model generated based on a knowledge base). That is, a structure of the model is displayed in the form of a tree. By thus visualizing the model, a person with knowledge can be notified of a relationship of an event item.

The result of Step S308 is incorporated in the displayed model. Specifically, a root node shows that 100 pieces of event data have been input to this model, and each leaf node displays a verification result. For example, a lower left leaf node shows that it is determined as a result of verification that 1 piece of data is normal and 7 pieces of data are abnormal out of 8 pieces of data predicated as being abnormal.

The rule candidate display region 1450 displays a rule candidate table 1460 and a threshold value display region 1490. The threshold value display region 1490 displays a threshold value for extraction of a rule candidate from the model displayed on the model display region 1410.

The rule candidate table 1460 has a check column 1462, a rule candidate No column 1464, an accuracy rate column 1466, an overall rate 1468, a normal data column 1470, an abnormal data column 1472, and a rule column 1474. Rule candidates can be listed by using the rule candidate table 1460. The check column 1462 is a check column for selecting a rule candidate in a checked row. The rule candidate No column 1464 stores therein information (rule candidate No) for uniquely identifying a rule candidate. The accuracy rate column 1466 stores therein an accuracy rate. The overall rate 1468 stores therein an overall rate. The overall rate is a ratio of the number of pieces of event data that have reached a leaf node that is a terminal node to all pieces of event data. The overall rate is 8% (8/100) at a lower left leaf node. The normal data column 1470 stores therein the number of pieces of event data whose result is normal. The abnormal data column 1472 stores therein the number of pieces of event data whose result is abnormal. The rule column 1474 stores therein a rule candidate. It is only necessary to generate a rule by tracking a route from a root node to a leaf node. For example, at the lower left leaf node, a rule “it is predicated that an abnormality occurs if humidity is equal to or higher than 43.5% and a heat cycle is equal to or larger than 22.95”.

When a row of the rule candidate table 1460 is selected, a corresponding route of the model in the model display region 1410 is displayed in an emphasized manner. For example, in a case where a second row of the rule candidate table 1460 is selected, the root node “100 in total”, a node “humidity 43.5% or more”, a node “heat cycle 22.95 or more”, and a node “abnormal normal: 1 abnormal: 7” are displayed in an emphasized manner. Examples of a way in which a node is displayed in an emphasized manner include displaying the node in a color different from other nodes, highlighting the node, and blinking the node.

By displaying the rule candidate table 1460, a person with knowledge is allowed to confirm a relationship, select an inappropriate rule (a rule that is definitely unnecessary) in the check column 1462, and delete such a rule by giving a deletion instruction. Furthermore, a rule candidate may be edited. In a case where a rule candidate is edited, the processing for generating a generic rule is performed again based on the edited rule candidate.

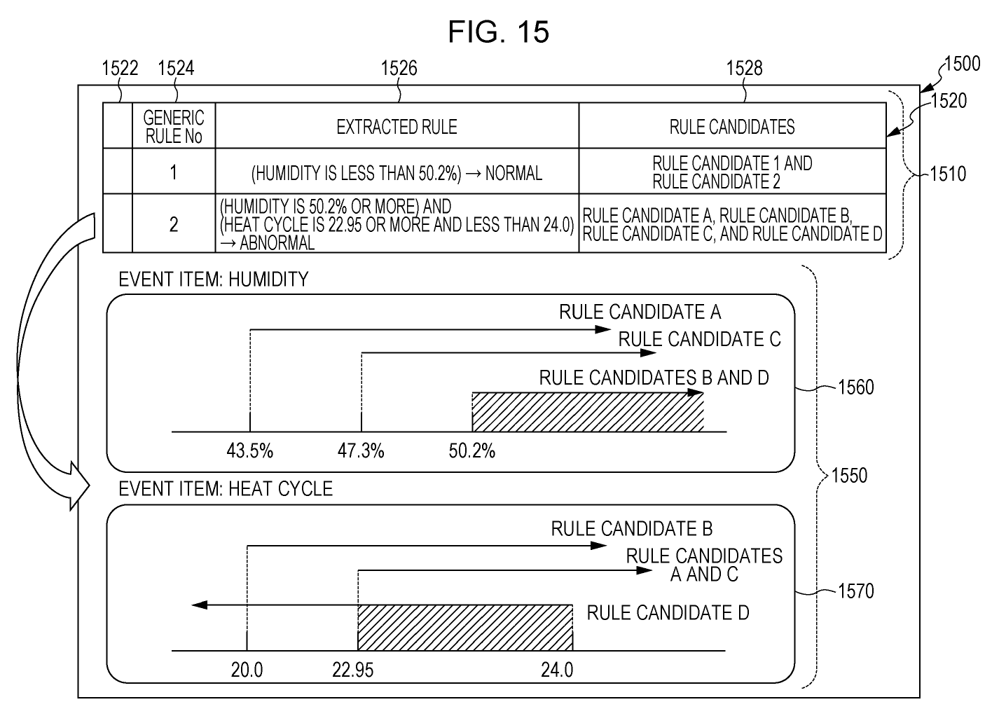

FIG. 15 is an explanatory view illustrating an example of a screen displayed according to the present exemplary embodiment (mostly by the user interface module 125).

A screen 1500 displays a rule candidate display region 1510 and an event item display region 1550. The event item display region 1550 is a region in which a range of a value of an event item is illustrated as a process for generating a generic rule.

The rule candidate display region 1510 displays a rule candidate table 1520. The rule candidate table 1520 is a list of an extracted generic rule and rule candidates from which the generic rule is extracted. The rule candidate table 1520 has a check column 1522, a generic rule No column 1524, an extracted rule column 1526, and a rule candidate column 1528. The check column 1522 is a check column for selecting a generic rule in a checked row. The generic rule No column 1524 stores therein information (generic rule No) for uniquely identifying a generic rule. The extracted rule column 1526 stores therein contents of the generic rule. The rule candidate column 1528 stores therein rule candidates from which the rule candidate has been generated.

When a row of the rule candidate table 1520 is selected, a relationship between rule candidates is displayed for each event item. By visualizing the relationship, a person with knowledge is notified of the relationship of the event item. For example, in a case where a second row of the rule candidate table 1520 is selected, a humidity rule display region 1560 and a heat cycle rule display region 1570 are displayed in the event item display region 1550.

By displaying the rule candidate display region 1510 and the event item display region 1550, a person with knowledge is allowed to confirm a relationship between rule candidates, select an inappropriate generic rule (e.g., a generic rule that is definitely unnecessary) in the check column 1522, and delete such a generic rule by giving a deletion instruction. Furthermore, a generic rule may be edited.

A value of the overall rate column 1468, a value of the accuracy rate column 1466, and the like may be additionally displayed for each rule candidate within the event item display region 1550. This is to allow a person with knowledge to determine whether or not to perform an editing operation. For example, a person with knowledge is allowed to make judgment such as deleting a rule candidate having a low overall rate or preferentially select a value of a rule candidate of a high accuracy rate as a range of a generic rule.

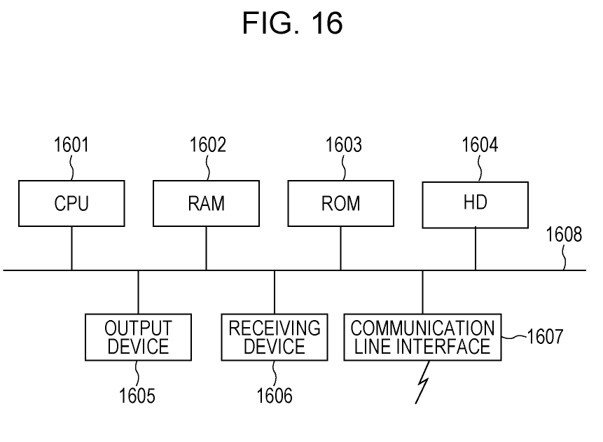

A hardware configuration of a computer that executes a program according to the present exemplary embodiment is a general computer as illustrated in FIG. 16, and examples thereof include a personal computer and a computer that can function as a server. That is, a specific example of the computer uses a CPU 1601 as a processing unit (arithmetic processing unit) and uses a RAM 1602, a ROM 1603, and a HD 1604 as memories. Examples of the HD 1604 include a hard disk and a solid state drive (SSD). The computer is made up of the CPU 1601 that executes programs such as the receiving module 105, the model generation module 110, the rule candidate extraction module 115, the generic rule generation module 120, the user interface module 125, the receiving presenting module 130, and the editing module 135, the RAM 1602 in which the programs and data are stored, the ROM 1603 in which programs and the like for activating the computer are stored, the HD 1604 that is an auxiliary storage device (e.g., a flash memory) in which the event data table 500, the generic rule table 1200, models, rule candidates, and the like are stored, a receiving device 1606 that receives data based on user's operation (examples thereof include action, voice, and a gaze) on a keyboard, a mouse, a touch screen, a microphone, a camera (examples thereof include a gaze detection camera), or the like, an output device 1605 such as a CRT, a liquid crystal display, or a speaker, a communication line interface 1607 for connection with a communication network such as a network interface card, and a bus 1608 that connects these members so that data can be exchanged. Plural such computers may be connected to one another over a network.

In the case of a computer program, a computer program that is software is loaded into a system having the above hardware configuration, and the exemplary embodiment is realized by cooperation of software and hardware resources.

The hardware configuration illustrated in FIG. 16 is one example of a configuration, and the present exemplary embodiment is not limited to the configuration illustrated in FIG. 16, as long as the modules described in the present exemplary embodiment can be executed. For example, some modules may be realized by dedicated hardware (e.g., an application specific integrated circuit (ASIC)), some modules may be provided in an external system and connected through a communication line, and plural systems illustrated in FIG. 16 may be connected to one another through a communication line so as to work in cooperation with one another. In particular, the modules may be incorporated not only into a personal computer, but also into a mobile information communication device, an information household appliance, a robot, a copying machine, a fax machine, a scanner, a printer, a multi-function printer, or the like.

The terms “equal to or larger than”, “equal to or smaller than”, “larger than”, and “smaller (less) than” in the comparison processes in the above exemplary embodiment may be “larger than”, “smaller (less) than”, “equal to or larger than”, and “equal to or smaller than”, respectively, as long as no inconsistency occurs in a combination.

The programs described above may be offered by being stored in a recording medium or may be offered by communication means. In this case, for example, the programs described above may be grasped as an invention of a “computer readable medium storing a program”.

The “computer readable medium storing a program” is a computer readable medium storing a program that is used to, for example, install, execute, or distribute the program.

Examples of the recording medium include digital versatile discs (DVD) such as “a DVD-R, a DVD-RW, and a DVD-RAM” that are standards set in a DVD forum or “DVD+R and DVD+RW” that are standards set in DVD+RW, compact discs (CDs) such as a read-only memory (CD-ROM), a CD recordable (CD-R), and a CD-rewritable (CD-RW), a Blu-ray (Registered Trademark) disc, a magnetooptic disc (MO), a flexible disc (FD), a magnetic tape, a hard disk, a read-only memory (ROM), an electrically erasable programmable read-only memory (EEPROM (Registered Trademark)), a flash memory, a random access memory (RAM), and a secure digital (SD) memory card.

All or part of the programs described above may be, for example, stored or distributed by being stored in the recording medium. Alternatively, all or part of the programs described above may be transferred by using communication, for example, by using a transfer medium such as a wired network, a wireless communication network, or a combination thereof used for a local area network (LAN), a metropolitan area network (MAN), a wide area network (WAN), the Internet, an intranet, or an extranet or may be carried on a carrier wave.

Furthermore, each of the programs described above may be part or all of another program or may be recorded in a recording medium together with another program. Furthermore, each of the programs described above may be recorded in a divided manner in plural recording media. Furthermore, each of the programs described above may be recorded in any form (e.g., compressed or encrypted) as long as the program can be restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives event data including a plurality of event items and values and results of the event items;
a model generation unit that generates a model having a tree structure combining the event items and the values of the event items;
an extraction unit that extracts, as a rule candidate, a combination of an event item and a value of the event item in the tree in a case where a matching rate between a result obtained by applying the event item and the value of the event item to the model and a result in the event item and the value of the event item is larger than a predetermined value or is equal to or larger than the predetermined value; and
a generic rule generation unit that generates a generic rule from a plurality of rule candidates.

2. The information processing apparatus according to claim 1, wherein
the model generation unit generates a plurality of models; and
the extraction unit extracts a rule candidate for obtaining a result by tracking trees in the plurality of models.

3. The information processing apparatus according to claim 1, wherein
the generic rule generation unit generates a generic rule from rule candidates having a common event item among a plurality of rule candidates.

4. The information processing apparatus according to claim 3, wherein
the generic rule generation unit uses, as a value of the generic rule, a range common to values of a plurality of rule candidates regarding a value of the common event item.

5. The information processing apparatus according to claim 3, wherein
the generic rule generation unit uses, as a value of the generic rule, a range that includes at least one of values of a plurality of rule candidates regarding a value of the common event item.

6. The information processing apparatus according to claim 1, further comprising a presenting unit that presents a process for extracting the rule candidate or a process for generating the generic rule.

7. The information processing apparatus according to claim 6, wherein
the presenting unit presents, as the process for extracting the rule candidate, the number of event items and values of the event items applied to the model, the matching rate, or a combination thereof.

8. The information processing apparatus according to claim 6, wherein
the presenting unit presents, as the process for generating the generic rule, a range of the value of the event item by illustration.

9. The information processing apparatus according to claim 6, wherein
the presenting unit presents the rule candidate or the generic rule in an editable manner.

10. The information processing apparatus according to claim 1, wherein
the model generation unit generates the model having the tree structure by machine learning.

11. The information processing apparatus according to claim 2, wherein
the model generation unit generates the model having the tree structure by machine learning.

12. The information processing apparatus according to claim 3, wherein
the model generation unit generates the model having the tree structure by machine learning.

13. The information processing apparatus according to claim 4, wherein
the model generation unit generates the model having the tree structure by machine learning.

14. The information processing apparatus according to claim 5, wherein
the model generation unit generates the model having the tree structure by machine learning.

15. The information processing apparatus according to claim 6, wherein
the model generation unit generates the model having the tree structure by machine learning.

16. The information processing apparatus according to claim 7, wherein
the model generation unit generates the model having the tree structure by machine learning.

17. The information processing apparatus according to claim 8, wherein
the model generation unit generates the model having the tree structure by machine learning.

18. The information processing apparatus according to claim 9, wherein
the model generation unit generates the model having the tree structure by machine learning.

19. A non-transitory computer readable medium storing a program causing a computer to execute a process comprising:
receiving event data including a plurality of event items and values and results of the event items;
generating a model having a tree structure combining the event items and the values of the event items;
extracting, as a rule candidate, a combination of an event item and a value of the event item in the tree in a case where a matching rate between a result obtained by applying the event item and the value of the event item to the model and a result in the event item and the value of the event item is larger than a predetermined value or is equal to or larger than the predetermined value; and
generating a generic rule from a plurality of rule candidates.
